(19) United States
(12) Patent Application Publication
(10) Pub. No.: US 2006/0137369 A1
(43) Pub. Date: Jun. 29, 2006

(54) Single sensor three-step refrigerant charge indicator

(75) Inventors: Timothy P. Galante, West Hartford, CT (US); Sivakumar Gopalnarayanan, Simsbury, CT (US); Dong Luo, South Windsor, CT (US); Pengju Kang, Hartford, CT (US); Robert H. Dold, Agawam, MA (US)

Correspondence Address: WALL MARJAMA & BILINSKI, 101 SOUTH SALINA STREET, SUITE 400, SYRACUSE, NY, 13202, US

(73) Assignee: Carrier Corporation, Farmington, CT (US)

(21) Appl. No.: 11/025,788

(22) Filed: Dec. 27, 2004

(51) Int. Cl. F25B 45/00; G01K 13/00

(52) U.S. Cl. 62/149; 62/77; 62/129

(57) ABSTRACT

A method and apparatus for determining the sufficiency of refrigerant charge in an air conditioning system using a single temperature sensor for sensing three different temperatures within the system to compute a condenser approach temperature difference, which in then compared with a predetermined optimal condenser approach temperature difference to indicate the charge condition of the system. The device includes an absorbent pad for sensing wet bulb temperatures, and is formed as a clamshell that can be clamped onto the condenser liquid line. A microprocessor is included to make the comparison and to appropriately display the result as a visual indication of charge adequacy.

### BACKGROUND OF THE INVENTION

This invention relates generally to air conditioning systems and, more particularly, to a method and apparatus for determining proper refrigerant charge in such systems.

Maintaining proper refrigerant charge level is essential to the safe and efficient operation of an air conditioning system. Improper charge level, either in deficit or in excess, can cause premature compressor failure. An over-charge in the system results in compressor flooding, which, in turn, may be damaging to the motor and mechanical components. Inadequate refrigerant charge can lead to increased power consumption, thus reducing system capacity and efficiency. Low charge also causes an increase in refrigerant temperature entering the compressor, which may cause thermal over-load of the compressor. Thermal over-load of the compressor can cause degradation of the motor winding insulation, thereby bringing about premature motor failure.

Charge adequacy has traditionally been checked using either the “superheat method” or “subcool method”. For air conditioning systems which use a thermal expansion valve (TXV), or an electronic expansion valve (EXV), the superheat of the refrigerant entering the compressor is normally regulated at a fixed value, while the amount of subcooling of the refrigerant exiting the condenser varies. Consequently, the amount of subcooling is used as an indicator for charge level. Manufacturers often specify a range of subcool values for a properly charged air conditioner. For example, a subcool temperature range between 10 and 15° F. is generally regarded as acceptable in residential cooling equipment. For air conditioning systems that use fixed orifice expansion devices instead of TXVs (or EXVs), the performance of the air conditioner is much more sensitive to refrigerant charge level. Therefore, superheat is often used as an indicator for charge in these types of systems. A manual procedure specified by the manufacturer is used to help the installer to determine the actual charge based on either the superheat or subcooling measurement. Table 1 summarizes the measurements required for assessing the proper amount of refrigerant charge.

TABLE 1
Measurements Required for Charge Level Determination

| | Superheat method | Subcooling method |
|---|---|---|
| 1 | Compressor suction temperature | Liquid line temperature at the |
| | | inlet to expansion device |
| 2 | Compressor suction pressure | Condenser outlet pressure |
| 3 | Outdoor condenser coil entering air | |
| | temperature | |
| 4 | Indoor returning wet bulb | |
| | temperature | |

To facilitate the superheat method, the manufacturer provides a table containing the superheat values corresponding to different combinations of indoor return air wet bulb temperatures and outdoor dry bulb temperatures for a properly charged system. This charging procedure is an empirical technique by which the installer determines the charge level by trial-and-error. The field technician has to look up in a table to see if the measured superheat falls in the correct ranges specified in the table. Often the procedure has to be repeated several times to ensure the superheat stays in a correct range specified in the table. Consequently this is a tedious test procedure, and difficult to apply to air conditioners of different makers, or even for equipment of the same maker where different duct and piping configurations are used. In addition, the calculation of superheat or subcool requires the measurement of compressor suction pressure, which requires intrusive penetration of pipes.

In the subcooling method, as with the superheat method, the manufacturer provides a table listing the liquid line temperature required as a function of the amount of subcooling and the liquid line pressure. Once again, the field technician has to look up in the table provided to see if the measured liquid line temperature falls within the correct ranges specified in the table. Thus, this charging procedure is also an empirical, time-consuming, and a trial-and-error process.

### SUMMARY OF THE INVENTION

Briefly, in accordance with one aspect of the invention, a simple and inexpensive refrigerant charge inventory indication method and apparatus using temperature measurements only is provided for an air conditioning system.

In accordance with another aspect of the invention, a hand held device includes a single temperature sensor which is used to sequentially sense the indoor wet bulb temperature, the condensing liquid line temperature and the outdoor temperature, and these temperatures are used to calculate a condenser approach temperature difference which, in turn, is compared with predetermined values to determine the refrigerant charge condition of an air conditioning system.

By yet another aspect of the invention, the device includes an absorbent pad that may be moistened for purposes of sensing the indoor wet bulb temperature.

By yet another aspect of the invention, the device includes a strap for securing the temperature sensor against the liquid line for sensing the condensing liquid line temperature.

By yet another aspect of the invention, the device includes a microprocessor for storing the sensed temperatures, comparing them with predetermined stored values, and indicating the charge condition of the system.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a schematic illustration of an air conditioning system with present invention incorporated therein.

FIGS. 2A-2D are perspective views of a charge indicator device in various stages of use in accordance with one embodiment of the present invention.

FIG. 3 is a flow chart indicating the method of testing for charge adequacy in accordance with the present invention.

### DESCRIPTION OF THE PREFERRED EMBODIMENT

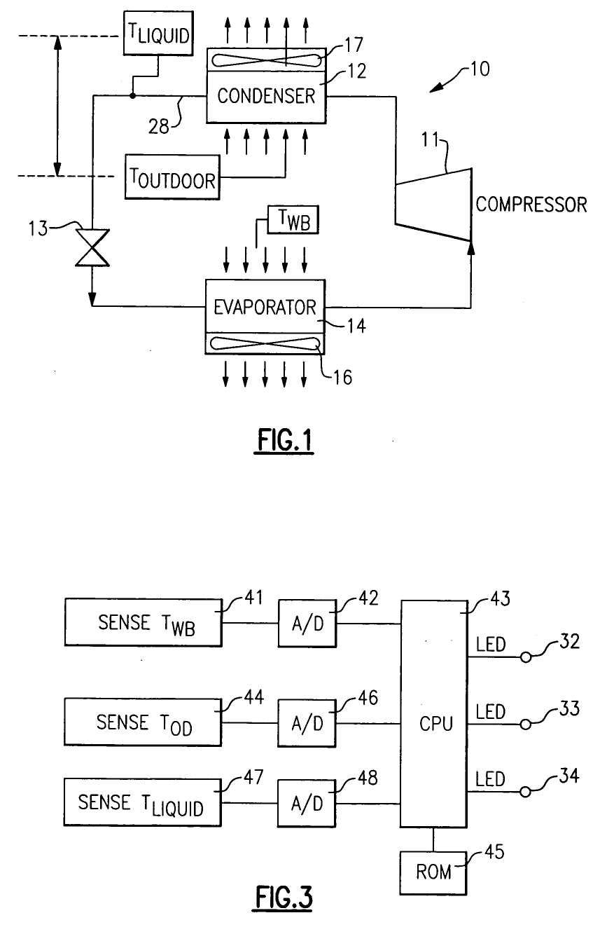

Referring now to FIG. 1, the invention is shown generally at 10 as incorporated into an air conditioning system having a compressor 11, a condenser 12, an expansion device 13 and an evaporator 14. In this regard, it should be recognized that the present invention is equally applicable for use with heat pump systems.

In operation, the refrigerant flowing through the evaporator 14 absorbs the heat in the indoor air being passed over the evaporator coil by the evaporator fan 16, with the cooled air than being circulated back into the indoor air to be cooled. After evaporation, the refrigerant vapor is pressurized in the compressor 11 and the resulting high pressure vapor is condensed into liquid refrigerant at the condenser 12, which rejects the heat in the refrigerant to the outdoor air being circulated over the condenser coil 12 by way of the condenser fan 17. The condensed refrigerant is then expanded by way of an expansion device 13, after which the saturated refrigerant liquid enters the evaporator 14 to continue the cooling process.

In a heat pump, during cooling mode, the process is identical to that as described hereinabove. In the heating mode, the cycle is reversed with the condenser and evaporator of the cooling mode acting as an evaporator and condenser, respectively.

It should be mentioned that the expansion device 13 may be a valve such as a TXV or an EXV which regulates the amount of liquid refrigerant entering the evaporator 14 in response to the superheat condition of the refrigerant entering the compressor 11. It may also be a fixed orifice, such as a capillary tube or the like.

In accordance with the present invention, there are three measured variables needed for assessing the charge level in an air conditioning system. These measured variables are liquid line temperature T_{liquid} outdoor temperature T_{OD} and indoor wet bulb temperature T_{wb}.

Each of these three temperatures are sensed with a single device having a single sensor and a microprocessor for storing these sensed temperatures, for storing predetermined algorithms and defining parameters for particular systems, and for indicating the charge status as a function of comparison of the sensed data with stored data.

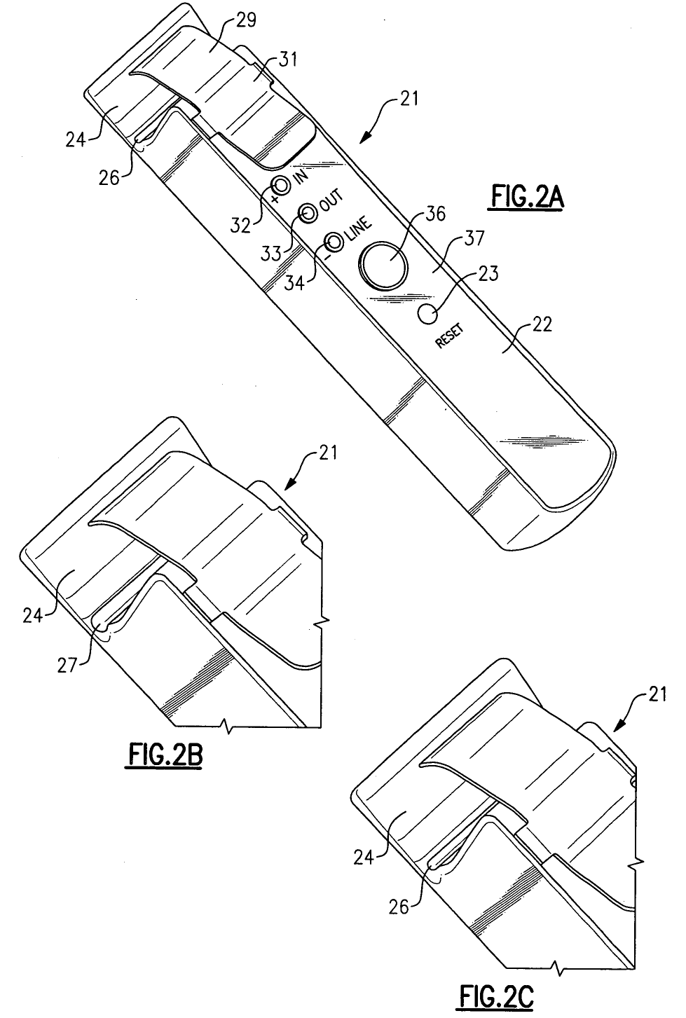

Referring now to FIGS. 2A-2D, the charging device is shown generally at 21 having a generally rectangular housing with a front face 23. Contained within the housing 22 is a microprocessor and, a ROM or other storage device for storing both sensed temperatures and predetermined characteristic data relative to various air conditioning models, as well as various algorithms that are used in comparing the predetermined data with the sensed data. Also included is circuitry for appropriately displaying the results of the charge adequacy test. These will be more fully discussed hereinafter.

Extending from the upper end of the device 22 is a flange 24 which acts as a shelf for supporting both the temperature sensing device and the liquid refrigerant line from the condenser for purposes of sensing that temperature.

Disposed at an inner edge on the upper side of the flange 24 is a sensor probe 26, which is an elongate cylindrical structure with its upper portion being exposed as shown in FIG. 2C. The sensor element that is associated with the sensor probe 26 is a thermocouple or the like, and the probe 26 is electronically connected to circuitry in the device 22 such that representative analog signals are sent to the processing circuitry within the housing 22 for processing as will be described hereinafter. It is this sensor probe that is used in sensing each of the three required temperatures, liquid line temperature T_{liquid}, outdoor temperature T_{OD} and indoor wet bulb temperature T_{wb}. The sensing of the outdoor temperature T_{OD} can be accomplished by simple taking the device 21 to an outdoor location and measuring the outdoor temperature with the sensor probe 26 in the condition as shown in FIG. 2C.

For purposes of sensing the indoor wet bulb temperature T_{wb}, it is necessary to maintain the sensor probe 26 in a wet condition. This is accomplished by placing a cylindrically shaped sock 27 over the sensor probe 26 as shown in FIG. 2B. The sock 27 is formed of an absorbent material which, when wetted, will allow for the sensing of the indoor wet bulb temperature T_{wb}. Preferably, before the indoor wet bulb temperature T_{wb} is taken, the assembly as shown in FIG. 2B, with the wetted sock, is made to undergo some movement, such as by a simple slinging motion to promote evaporation of the water from the wet sock to thereby present a proper condition for sensing the indoor wet bulb temperature T_{wb}. Again, that sensed temperature is converted to an analog signal and sent to the circuitry within the housing 22 for processing.

Finally, for purposes of measuring the third required temperature, the liquid line temperature T_{liquid}, it is necessary to place the sensor probe 26 in direct contact with the condenser liquid line 28 as shown in FIG. 2D. In order to maintain the direct contact relationship, a strap 29 is provided to be placed over the liquid line 28 and then tightly secured in place by a clasp 31 so as to maintain that firm position. Again, the T_{liquid} temperature that is sensed is indicated by an analog signal from the sensor probe 26 which is sent to the processing circuitry within the housing 22.

Referring now to the front panel 23 of the housing 22 as shown in FIG. 2A, there are three LEDs, 32, 33 and 34 which provide indications to the operator as to the status of the process by which the temperatures are sensed and the signals are appropriately processed. Also provided is an activator button 36 and a reset button 37.

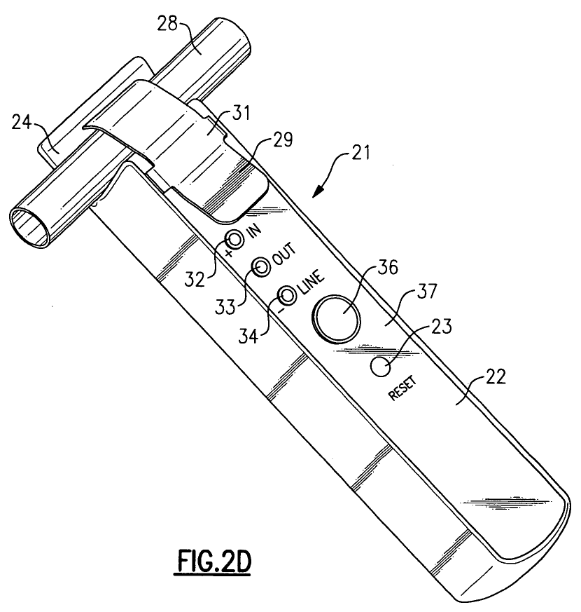

In operation, as shown in FIG. 3, the device is placed in the condition as shown in FIG. 2B with the wetted sock applied, and the indoor wet bulb temperature T_{wb} is sensed by pressing the activator button 36. As the temperature is sensed as shown in block 41 of FIG. 3, an analog signal representative of the sensed temperature is passed to an A/D converter 42 which then passes a representative digital signal to the CPU 43 and to the read-only-memory 45 to be stored. At that point, the LED 32 will be lighted to indicate that this temperature has appropriately been sensed and stored.

The wet sock 27 is then removed and the device as shown in FIG. 2C is taken to an outdoor location to sense the outdoor temperature T_{OD} as shown at block 44 of FIG. 3. Again, the analog signal representative of the outdoor temperature is sent to an A/D converter 46 which in turn sends a representative digital signal to the CPU 43 and to the read-only-memory 43 for storage. The LED 33 then lights up to indicate that this temperature has been sensed and stored as desired.

Finally, the device 21 is taken to the condenser liquid line 28 and is attached to that line as shown in FIG. 2D such that the liquid line temperature can be sensed as shown in block 47 of FIG. 3. Again, a representative analog signal is sent to an A/D converter 48 which then converts the signal to representative digital signal which is passed to the CPU 43 and the read-only-memory 45 and stored. The LED 34 is then automatically lighted to indicate that this temperature has been appropriately sensed and stored.

The processing of the three stored temperatures is accomplished by the CPU 43 by comparing the sensed liquid line temperature T_{liquid} for a given sensed outdoor temperature T_{OD} and indoor wet bulb temperature T_{wb} with an optimal liquid line temperature Tₒₚₜᵢₘₐₗ for the same outdoor temperature and indoor wet bulb temperatures. These optimal values are stored in the read only memory 45 for each of various air conditioning system models as described in U.S. patent application No. (docket no.: 210_{—}706) filed concurrently herewith, assigned to the assignee of the present invention and incorporated herein by reference. When the comparison has been made, the difference between the values calculated on the basis of the sensed temperatures and the values that are representative of an optimal condition will indicate whether the system is undercharged, overcharged or properly charged with refrigerant. The LEDS 32, 33 and 34 are then again used to indicate one of these three possibilities. That is, the circuitry is provided within the device 21 such that if the analysis indicates that a proper charge has been found, then the LED 33 will be automatically lighted. If it is found that refrigerant charge is needed in order to present an optimal condition, then the LED 32 will be lighted to indicate that refrigerant must be added. If it is found that the system is overcharged, then the LED 34 will be lighted to indicate that refrigerant must be removed.

While the present invention has been particularly shown and described with reference to a preferred embodiment as illustrated in the drawings, it will be understood by one skilled in the art that various changes in detail may be effected therein without departing from the true spirit and scope of the invention as defined by the claims.

We claim:

1. A method of determining the sufficiency of refrigerant charge in an air conditioning system device having a single temperature sensor, comprising the steps of:
providing an absorbent pad in combination with said temperature sensor such that said sensor is capable of sensing both wet bulb and dry bulb temperatures;
wetting said pad and sensing an indoor wet bulb temperature of the system;
removing or allowing said pad to dry and then using said sensor to sense the outdoor dry bulb temperature;
placing said sensor in direct engagement with the liquid refrigerant line from the condenser coil and sensing the temperature thereof; and
on the basis of those three sensed temperatures, determining whether the refrigerant charge in the system is adequate.

2. A method as set forth in claim 1 wherein said step of determining whether the refrigerant charge in the system is adequate is accomplished by first computing a condenser approach temperature difference and comparing this difference with a predetermined optimal difference for the particular system.

3. A method as set forth in claim 1 wherein said comparison is made by a microprocessor.

4. A method as set forth in claim 3 wherein said microprocessor is disposed within said device.

5. A method as set forth in claim 4 wherein said device further includes a display mechanism and wherein the method further includes the step of displaying the results of the comparison.

6. A method as set forth in claim 1 wherein, if the determination indicates that the system is low on charge, including the further step of maintaining said sensor in direct engagement with the liquid refrigerant line while adding charge until the determination is made that the charge in the system is adequate.

7. A method as set forth in claim 1 wherein said device includes a strap disposed around one side of said sensor and further wherein said step of placing said sensor in direct engagement with the liquid refrigerant line is followed by the step of securing said strap against said refrigerant line.

8. An apparatus for determining the sufficiency of refrigerant charge in an air conditioning system having a compressor, a condenser coil, an expansion device and an evaporator coil fluidly connected in serial refrigerant flow relationship, comprising:
a single temperature sensor for sequentially sensing the indoor wet bulb temperature of the system, the outdoor dry bulb temperature, and the condenser liquid line temperature of the system;
an absorbent pad associated with said temperature sensor for facilitating the sensing of the indoor wet bulb temperature;
means within said device for storing said sensed temperatures for computing a condenser approach temperature difference as a function thereof;
a second storage means in said device for storing an optimal condenser approach temperature difference for said system; and
comparison means within said device for comparing said computed condenser approach temperature difference with said optimal condenser approach temperature difference.

9. An apparatus as set forth in claim 8 and including display means in said apparatus for displaying the results of said comparison.

10. Apparatus as set forth in claim 8 wherein said first storage means comprises a read only memory.

11. Apparatus as set forth in claim 8 wherein said second storage means comprises a read only memory.

12. Apparatus as set forth in claim 8 wherein said comparing means comprises a microprocessor.

13. Apparatus as set forth in claim 8 wherein said device includes a strap for urging said sensor against the condenser liquid line.

14. Apparatus as set forth in claim 13 and including means for sensing said strap in position against the condenser liquid line.
